(19) United States
(12) Patent Application Publication
(10) Pub. No.: US 2024/0314821 A1
(43) Pub. Date: Sep. 19, 2024

(54) METHOD FOR SENSING NODE SELECTION, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Xinlei YU, Dongguan (CN); Cong SHI, Dongguan (CN); Yang LIU, Dongguan (CN)

(21) Appl. No.: 18/671,737

(22) Filed: May 22, 2024

Related U.S. Application Data
(63) Continuation of application No. PCT/CN2021/132405, filed on Nov. 23, 2021.

(51) Int. Cl. H04W 72/40; H04W 48/16

(52) U.S. Cl. CPC H04W 72/40; H04W 48/16

(57) ABSTRACT

A method for sensing node selection, is provided. The method is applied to a terminal device. The method includes the following. A sensing request sent by a network device is received, and assistance information is sent to the network device according to the sensing request, where the assistance information is used for determining at least one candidate sensing node, and the at least one candidate sensing node is used for assisting the network device to select at least one sensing node that is to work with the terminal device to perform sensing.

### CROSS-REFERENCE TO RELATED APPLICATION(S)

This application is a continuation of International Application No. PCT/CN2021/132405, filed Nov. 23, 2021, the entire disclosure of which is hereby incorporated by reference.

### TECHNICAL FIELD

The disclosure relates to the field of wireless communication, and more particularly, to a method for sensing node selection, a terminal device, and a network device.

### BACKGROUND

Radio electromagnetic wave signals used by a cellular network can not only be used for wireless data transmission and communication but also be used for environment sensing, for example, action recognition, gesture recognition, breathing monitoring, terminal-device moving speed measurement, environment imaging, weather monitoring, etc.

An application function (AF) sends a sensing request for a terminal device to a core network device. The core network device selects a secondary access network device or a secondary terminal device that is to participate in sensing, and sends a sensing indication to the terminal device, so as to instruct the terminal device to perform sensing with the secondary access network device or the secondary terminal device.

Since distribution of other terminal devices around the terminal device or access network devices around the terminal device cannot be accurately known by the core network device, the core network device is unable to configure a suitable secondary terminal device or secondary access network device for the terminal device.

### SUMMARY

Embodiments of the disclosure provide a method for sensing node selection, a terminal device, and a network device.

According to an aspect of the disclosure, a method for sensing node selection is provided, which is applied to a terminal device. The method includes the following. A sensing request sent by a network device is received, and assistance information is sent to the network device according to the sensing request, where the assistance information is used for determining at least one candidate sensing node, and the at least one candidate sensing node is used for assisting the network device to select at least one sensing node that is to work with the terminal device to perform sensing.

According to an aspect of the disclosure, a terminal device is provided. The terminal device includes a transceiver, a processor coupled to the transceiver, and a memory storing a computer program which, when executed by the processor, causes the terminal device to receive a sensing request sent by a network device, and send assistance information to the network device according to the sensing request, where the assistance information is used for determining at least one candidate sensing node, and the at least one candidate sensing node is used for assisting the network device to select at least one sensing node that is to work with a terminal device to perform sensing.

According to an aspect of the disclosure, a network device is provided. The network device includes a transceiver, a processor coupled to the transceiver, and a memory storing a computer program which, when executed by the processor, causes the network device to send a sensing request to a terminal device, where the sensing request is used for instructing the terminal device to send assistance information, and the assistance information is used for determining at least one candidate sensing node; and select, from the at least one candidate sensing node, at least one sensing node that is to work with the terminal device to perform sensing.

Other features and aspects of the disclosed features will become apparent from the following detailed description, taken in conjunction with the accompanying drawings, which illustrate, by way of example, the features in accordance with implementations the disclosure. The summary is not intended to limit the scope of any implementations described herein.

### BRIEF DESCRIPTION OF THE DRAWINGS

To describe technical solutions of embodiments of the disclosure more clearly, the following will give a brief introduction to the accompanying drawings used for describing the embodiments. Apparently, the accompanying drawings described below illustrate merely some embodiments of the disclosure. Based on these accompanying drawings, those of ordinary skill in the art may also obtain other drawings without creative effort.

FIG. 1 is a schematic diagram of a system architecture provided in an exemplary embodiment of the disclosure.

FIG. 2 is a schematic diagram of a system architecture provided in an exemplary embodiment of the disclosure.

FIG. 3 is a flow chart of a method for sensing node selection provided in an exemplary embodiment of the disclosure.

FIG. 4 is a flow chart of a method for sensing node selection provided in an exemplary embodiment of the disclosure.

FIG. 5 is a flow chart of a method for sensing node selection provided in an exemplary embodiment of the disclosure.

FIG. 6 is a flow chart of a method for sensing node selection provided in an exemplary embodiment of the disclosure.

FIG. 7 is a flow chart of a method for sensing node selection provided in an exemplary embodiment of the disclosure.

FIG. 8 is a flow chart of a method for sensing node selection provided in an exemplary embodiment of the disclosure.

FIG. 9 is a flow chart of a method for sensing node selection provided in an exemplary embodiment of the disclosure.

FIG. 10 is a structural block diagram of an apparatus for sensing node selection provided in an exemplary embodiment of the disclosure.

FIG. 11 is a structural block diagram of an apparatus for sensing node selection provided in an exemplary embodiment of the disclosure.

FIG. 12 is a schematic structural diagram of a communication device provided in an exemplary embodiment of the disclosure.

### DETAILED DESCRIPTION

In order to make the objectives, technical solutions, and advantages of the disclosure clearer, implementations of the disclosure will be described in further detail below with reference to the accompanying drawings.

The network architecture and service scenario described in embodiments of the disclosure are intended to describe the technical solutions of the embodiments of the disclosure more clearly, and do not constitute limitation on the technical solutions provided in the embodiments of the disclosure. Those of ordinary skill in the art can appreciate that, with evolution of network architectures and emergence of new service scenarios, for similar technical problems, the technical solutions provided in the embodiments of the disclosure are also applicable.

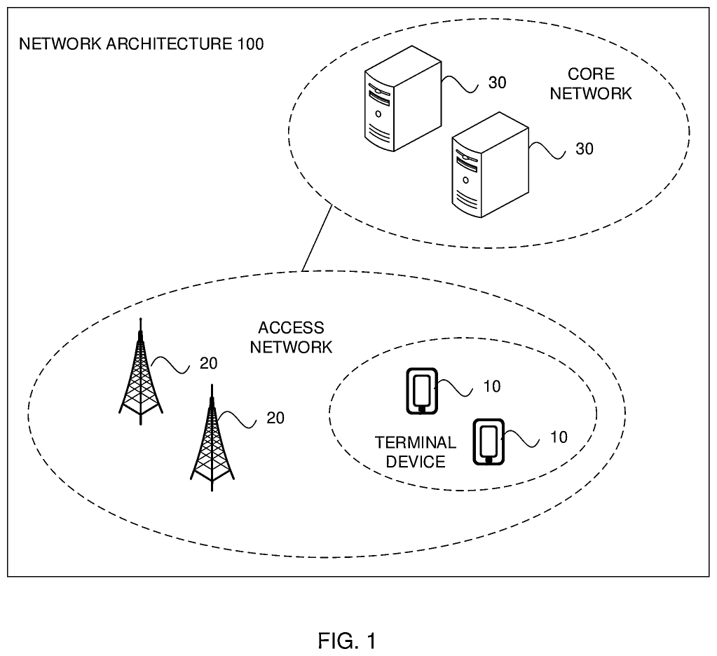

Referring to FIG. 1, FIG. 1 is a schematic diagram of a network architecture 100 provided in an embodiment of the disclosure. The network architecture 100 may include a terminal device 10, an access network device 20, and a core network device 30.

The terminal device 10 may refer to a user equipment (UE), an access terminal, a subscriber unit, a subscriber station, a mobile station, a remote station, a remote terminal, a mobile device, a wireless communication device, a user agent, or a user device. Optionally, the terminal device 10 may also be a cellular telephone, a cordless telephone, a session initiation protocol (SIP) telephone, a wireless local loop (WLL) station, a personal digital assistant (PDA), various devices having wireless communication functions such as a handheld device, a computing device, or other processing devices connected to a wireless modem, an in-vehicle device, or a wearable device, a terminal device in a 5th-generation system (5GS) or a terminal device in a future evolved public land mobile network (PLMN), etc., and embodiments of the disclosure are not limited in this regard. For the convenience of illustration, the foregoing devices are collectively referred to as “terminal device”. The quantity of terminal devices 10 is generally multiple, and there may be one or more terminal devices 10 distributed in a cell managed by each access network device 20.

The access network device 20 is a device deployed in an access network to provide wireless communication functions for the terminal device 10. The access network device 20 may include various forms of macro base stations, micro base stations, relay stations, access points, etc. The names of a device having functions of the access network device may be different in systems adopting different radio access technologies, which is, for example, referred to as a gNodeB or a gNB in a 5G new radio (NR) system. With evolution of communication technology, the name “access network device” may change. For the convenience of illustration, in embodiments of the disclosure, the foregoing apparatus for providing wireless communication functions for the terminal device 10 is collectively called “access network device”. Optionally, a communication relationship may be established between the terminal device 10 and the core network element 30 via the access network device 20. Exemplarily, in a long-term evolution (LTE) system, the access network device 20 may be an evolved universal terrestrial radio access network (EUTRAN) or one or more eNodeBs in the EUTRAN. In a 5G NR system, the access network device 20 may be a RAN or one or more gNBs in the RAN. In the embodiments of the disclosure, a “network device” refers to the access network device 20 such as a base station, unless specified otherwise.

The core network device 30 is a device deployed in a core network (Core). Functions of the core network device 30 are mainly to provide a user connection, manage a user, complete service carrying, and act as a bearer network to provide an interface to an external network. For example, the core network device in a 5G NR system may include network elements such as an access and mobility management function (AMF), a user plane function (UPF), and a session management function (SMF).

In an example, the access network device 20 and the core network device 30 communicate with each other with some air interface technology, such as an NG interface in a 5G NR system. The access network device 20 and the terminal device 10 communicate with each other with sone air interface technology, such as a UE-UTRAN (Uu) interface.

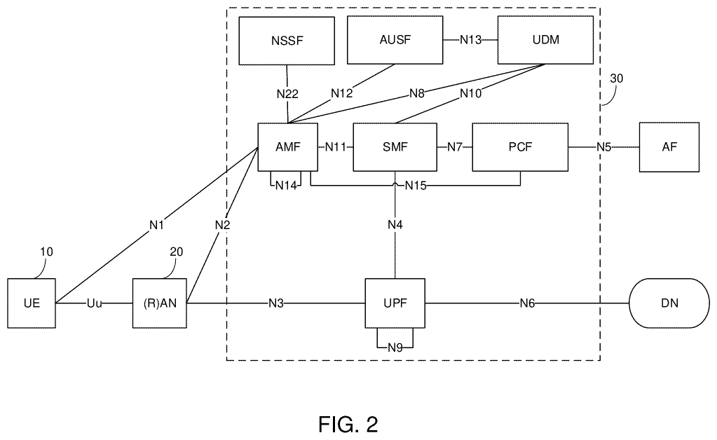

Referring to FIG. 2, FIG. 2 is a schematic diagram of a network architecture provided in another embodiment of the disclosure. The network architecture may include a terminal device 10, an access network device 20, and a core network device 30.

The core network device 30 includes a network slice selection function (NSSF), an authentication server function (AUSF), a unified data management (UDM), an AMF, an SMF, a policy control function (PCF), a UPF, and a sensing function (SF).

A UE establishes an access stratum (AS) connection with an access network (AN) over a Uu interface in order for AS message interaction and wireless data transmission. The UE establishes a non-access stratum (NAS) connection with the AMF via NI interface in order for NAS message interaction. The AMF is a mobility management function in the Core. The SMF is a session management function in the Core. In addition to mobility management of the UE, the AMF is also responsible for forwarding a session management related message between the UE and the SMF. The PCF is a policy management function in the Core, and is responsible for formulating policies related to mobility management, session management, charging, etc. of the UE. The PCF performs data transmission with an external application function (AF) via N5 interface. The UPF is a user plane function in the Core, which performs data transmission with an external data network (DN) via N6 interface, and performs data transmission with the AN via N3 interface.

The “5G NR system” in embodiments of the disclosure may also be referred to as “5G system” or “NR system”, but the meaning thereof can be understood by those skilled in the art. The technical solutions described in embodiments of the disclosure may be applied to an LTE system, or may be applied to a 5G NR system, or may be applied to a future evolved system of a 5G NR system, or may be applied to other communication systems such as a narrow band Internet of things (NB-IoT) system, and the disclosure is not limited in this regard.

An existing cellular network, including a 5G network, is only used for communication, but a radio electromagnetic wave signal used by a cellular network not only can be used for wireless data transmission and communication, but also has environment sensing capability, such as user action or gesture recognition, breathing monitoring, terminal moving speed measurement, environment imaging, and weather monitoring. Therefore, in addition to communication and data transmission, a future cellular network can also be used for obtaining sensing information.

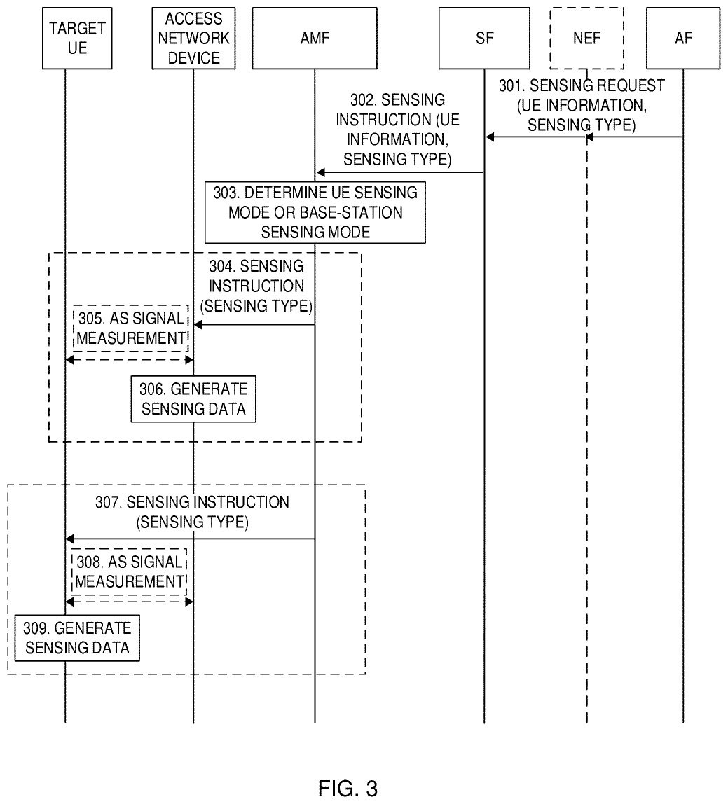

In the related art, a 5G network supports a sensing capability, and supports a sensing functionality with aid of an SF and corresponding procedures in a 3^{rd} generation partnership project (3GPP) network. FIG. 3 is a flow chart illustrating controlling an access network device or a UE to perform UE-level sensing operations. The method includes the following.

At block 301, an AF sends a sensing request for a target UE to a core network in a 3GPP network, where the sensing request carries information of the target UE and a sensing type.

A wireless sensing scenario of harmonized communication and sensing (HCS) mainly includes the following: 1) base station (access network device) echo sensing link: a base station (access network device) sends a sensing signal and receives an echo signal; 2) base station-base station sensing link: base station B receives a sensing signal sent by base station A; 3) air-interface uplink sensing link: a base station receives a sensing signal sent by a terminal; 4) air-interface downlink sensing link: a terminal receives a sensing signal sent by a base station; 5) terminal echo sensing link: a terminal sends a sensing signal and receives an echo signal; 6) terminal-terminal sensing link: terminal B receives a sensing signal sent by terminal A.

Based on the foregoing scenarios, the sensing types may include: access network device echo sensing, access network device-access network device sensing, air-interface uplink sensing, air-interface downlink sensing, terminal device echo sensing, terminal device-terminal device sensing, etc.

At block 302, via an SF or an AMF, the core network selects an access network device or secondary UE that is to participate in sensing, triggers sensing-related wireless measurement, starts measurement of sensing information, and generates a sensing result. For example, the SF sends a sensing instruction to the AMF, where the sensing instruction carries the information of the target UE and the sensing type.

At block 303, the AMF determines a UE sensing mode or a base-station sensing mode.

At block 304, if the sensing type is air-interface uplink sensing, the AMF sends the sensing instruction to the access network device, where the sensing instruction contains the sensing type.

At block 305, the access network device and the target UE perform AS signal measurement.

At block 306, the access network device generates sensing data.

At block 307, if the sensing type is air-interface downlink sensing, the AMF sends the sensing instruction to the target UE, where the sensing instruction contains the sensing type.

At block 308, the target UE and the access network device perform AS signal measurement.

At an early stage of 5G HCS, a sensing signal for sensing may be multiplexed with an existing air-interface signal, for example, a sounding reference signal (SRS), a demodulation reference signal (DMRS), a channel state information reference signal (CSI-RS), a phase tracking reference signal (PTRS), a positioning reference signal (PRS), etc. Sensing is performed through multiplexing with an existing air-interface signal, so that too much air-interface enhancement is not introduced.

At block 309, the target UE generates sensing data.

In the above solution, with respect to the target UE, the SF or the AMF in the core network is responsible for selecting a suitable access network device(s) (gNB) or secondary UE(s) that is to perform sensing-related operations. For other UEs around the target UE, since the SF or the AMF cannot know distribution of the UEs around the target UE, the SF or the AMF is unable to configure for the target UE a suitable secondary UE that is to perform sensing operations. For gNBs around the target UE, although the SF or the AMF can know some about distribution of the gNBs around the target UE, the SF or the AMF is still unable to configure accurately a suitable neighbor gNB for the target UE to perform sensing except a serving gNB for the target UE.

With regard to the problem described above, embodiments of the disclosure provide a method for sensing node selection. A terminal device feeds back assistance information to a network device, so that the network device selects a sensing node based on the assistance information.

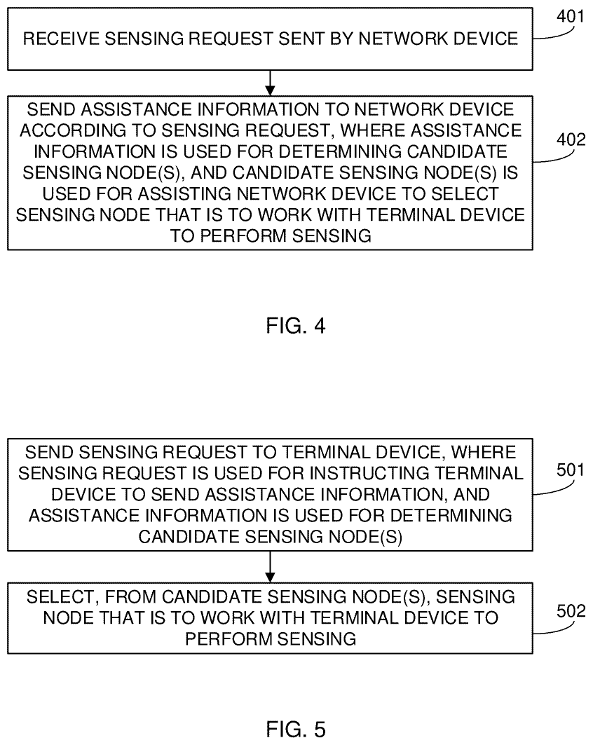

Referring to FIG. 4, FIG. 4 is a flow chart of a method for sensing node selection provided in an embodiment of the disclosure. The method may be performed by the terminal device in the system architecture illustrated in FIG. 1 or FIG. 2. The method includes the following.

At block 401, a sensing request sent by a network device is received.

The network device sends the sensing request to a terminal device, and the terminal device receives the sensing request.

The network device includes at least one of: an access network device (serving access network device) or a core network device. In the case where the network device is the core network device, the method performed by the network device in the embodiments may be executed by an AMF or an SF of the core network device.

The access network device refers to a network device in an access network accessed by the terminal device, or the access network device refers to a network device in a cell accessed by the terminal device. The access network device may also be referred to as a “serving access network device”, a “serving gNB”, or a “serving base station”, i.e. the access network device is an access network device serving the terminal device, that is, the terminal device communicates with the core network device via the access network device.

In addition to the serving access network device described above, a secondary access network device is also defined in the embodiments. The secondary access network device refers to an access network device that is not accessed by the terminal device and is instructed to work with the terminal device to perform sensing. In the case where the current sensing is terminal device-secondary access network device sensing, the network device may select for the terminal device a secondary access network device that is to perform the current sensing from multiple candidate secondary access network devices. Exemplarily, the candidate secondary access network device is an access network device in a neighbor cell for the terminal device.

In an optional implementation, the secondary access network device may also be defined as an access network device that works with the terminal device to perform sensing. In this case, the secondary access network device may also be a serving access network device.

In the case where the secondary access network device and the terminal device perform sensing, the secondary access network device sends a sensing signal to the terminal device, so that the terminal device performs air-interface downlink sensing based on the sensing signal; alternatively, the terminal device sends a sensing signal to the secondary access network device, so that the secondary access network device performs air-interface uplink sensing based on the sensing signal. Exemplarily, there may be at least one secondary access network device that can perform current sensing with the terminal device.

Correspondingly, the terminal device (local end) is a terminal device that can perform the method of the embodiments, and a secondary terminal device is a terminal device that is instructed to work with the terminal device (local end) to perform sensing. If the current sensing is terminal device-terminal device sensing, the network device may select for the terminal device a secondary terminal device that is to perform the current sensing from multiple candidate secondary terminal devices. Exemplarily, the candidate secondary terminal device is a terminal device that is located around the terminal device and is capable of performing sidelink (SL) communication with the terminal device.

In the case where the terminal device and the secondary terminal device perform sensing, the secondary terminal device sends a sensing signal to the terminal device, so that the terminal device performs UE-UE(s) sensing based on the sensing signal; alternatively, the terminal device sends a sensing signal to the secondary terminal device, so that the secondary terminal device performs UE-UE(s) sensing based on the sensing signal. Exemplarily, there may be at least one secondary terminal device that can perform current sensing with the terminal device.

Exemplarily, the sensing request contains at least one of: a sensing type or indication information.

The sensing type includes at least one of: gNB echo sensing, gNB-gNB(s) sensing, UE-gNB downlink sensing, UE-gNB uplink sensing, UE echo sensing, or UE-UE(s) sensing.

The indication information instructs the terminal device to report assistance information. The indication information differs with regard to different assistance information that is to be reported by the terminal device. For example, if the terminal device needs to report a secondary access network device, the indication information is first indication information. If the terminal device needs to report a secondary terminal device, the indication information is second indication information. If the terminal device needs to report location information, the indication information is third indication information.

At block 402, assistance information is sent to the network device according to the sensing request, where the assistance information is used for determining a candidate sensing node(s), and the candidate sensing node(s) is used for assisting the network device to select a sensing node that is to work with the terminal device to perform sensing.

Exemplarily, the sensing request may indicate a type of the sensing node that is to work with the terminal device to perform sensing.

For example, if the sensing request indicates that the sensing type is UE-gNB downlink sensing or UE-gNB uplink sensing, the sensing node is a secondary access network device. If the sensing request indicates that the sensing type is UE-UE(s) sensing, the sensing node is a secondary terminal device.

For another example, if the indication information in the sensing request instructs the terminal device to report a candidate secondary access network device, the sensing node is a secondary access network device. If the indication information in the sensing request instructs the terminal device to report a candidate secondary terminal device, the sensing node is a secondary terminal device.

If the sensing request indicates the type of the sensing node, the terminal device sends the assistance information to the network device, where the assistance information indicates a candidate sensing node(s) of the type.

Exemplarily, the sensing request may also directly indicate the sensing node. If the sensing request indicates the sensing node, the terminal device does not have to report the assistance information. Therefore, if the sensing request indicates the type of the sensing node but does not contain the sensing node, the terminal device sends the assistance information to the network device, where the assistance information indicates the candidate sensing node(s) of the type.

Exemplarily, the sensing request may contain third indication information, where the third indication information instructs the terminal device to report location information.

If the sensing request instructs the terminal device to report the location information, the terminal device sends the assistance information to the network device, where the assistance information includes the location information of the terminal device.

Exemplarily, the sensing request may not indicate the sensing type, that is, the type of the sensing node that is to work with the terminal device to perform sensing is not yet determined by the network device. The network device determines, according to the assistance information reported by the terminal device, the type of the sensing node that is to work with the terminal device to perform sensing.

In an optional implementation, if the sensing request neither indicates the sensing type nor indicates which type of assistance information is to be reported by the terminal, the terminal device reports to the network device all the assistance information that can be obtained.

In another optional implementation, if the sensing request does not indicate the sensing type but indicates which type of assistance information is to be reported by the terminal, the terminal device reports at least one type of assistance information according to an indication in the sensing request.

The assistance information is used for assisting the network device to select a sensing node. The assistance information assists the network device to determine an available sensing node(s) located around the terminal device. The assistance information is used for assisting the network device to determine an available sensing node(s) capable of performing sensing with the terminal device.

The assistance information may also be referred to as “sensing-node-selection assistance information”.

Exemplarily, the assistance information may include the candidate sensing node(s), or the assistance information includes the location information of the terminal device.

That is, after receiving the sensing request sent by the network device, the terminal device determines a candidate sensing node(s) capable of performing sensing with the terminal device or determines a candidate sensing node(s) located around the terminal device, generates the assistance information according to the candidate sensing node(s), and sends the assistance information to the network device.

Alternatively, after receiving the sensing request sent by the network device, the terminal device performs positioning of the terminal device to obtain the location information of the terminal device, generates the assistance information according to the location information, and sends the assistance information to the network device.

The network device receives the assistance information, determines a candidate sensing node(s) based on the assistance information, and selects a sensing node for the terminal device from the candidate sensing node(s). After determining the sensing node, the network device sends a sensing instruction to at least one of the terminal device or the sensing node. The terminal device/the sensing node receives the sensing instruction and performs sensing.

Exemplarily, sensing may be applied in at least one of: measuring a moving speed of the terminal device, measuring a location of the terminal device, weather monitoring, environment imaging, gesture recognition, or breathing monitoring.

As can be seen, according to the method provided in the embodiments, after receiving the sensing request sent by the network device, the terminal device feeds back the assistance information to the network device, where the assistance information is used for determining a candidate sensing node(s) capable of performing sensing with the terminal device, so that the network device selects, from the candidate sensing node(s), a sensing node that is to participate in the current sensing. The assistance information is reported by the terminal device, and as such, the network device can determine, based on the assistance information, other terminal devices or access network devices located near the terminal device, thereby selecting a suitable sensing node for the terminal device.

Referring to FIG. 5, FIG. 5 is a flow chart of a method for sensing node selection provided in an embodiment of the disclosure. The method may be performed by the network device in the system architecture illustrated in FIG. 1 or FIG. 2. The method includes the following.

At block 501, a sensing request is sent to a terminal device, where the sensing request is used for instructing the terminal device to send assistance information, and the assistance information is used for determining a candidate sensing node(s).

“The assistance information is used for determining the candidate sensing node(s)” means that: 1) The assistance information indicates the candidate sensing node(s); 2) The assistance information includes location information of the terminal device, and the candidate sensing node(s) is determined based on the location information.

At block 502, a sensing node that is to work with the terminal device to perform sensing is selected from the candidate sensing node(s).

A network device selects a sensing node from the candidate sensing node(s).

As can be seen, according to the method provided in the embodiments, after receiving the sensing request sent by the network device, the terminal device feeds back the assistance information to the network device, where the assistance information is used for determining a candidate sensing node(s) capable of performing sensing with the terminal device, so that the network device selects, from the candidate sensing node(s), a sensing node that is to participate in the current sensing. The assistance information is reported by the terminal device, and as such, the network device can determine, based on the assistance information, other terminal devices or access network devices located near the terminal device, thereby selecting a suitable sensing node for the terminal device.

Exemplarily, with regard to different assistance information reported by the terminal device, the following three exemplary embodiments are given below, but the method provided in the disclosure is not limited to the three exemplary embodiments: 1. The assistance information indicates a candidate secondary terminal device(s); 2. The assistance information indicates a candidate secondary access network device(s); 3. The assistance information includes location information of the terminal device; 4. The assistance information includes at least one type of the three types of assistance information described above.

1. The assistance information indicates a candidate secondary terminal device(s).

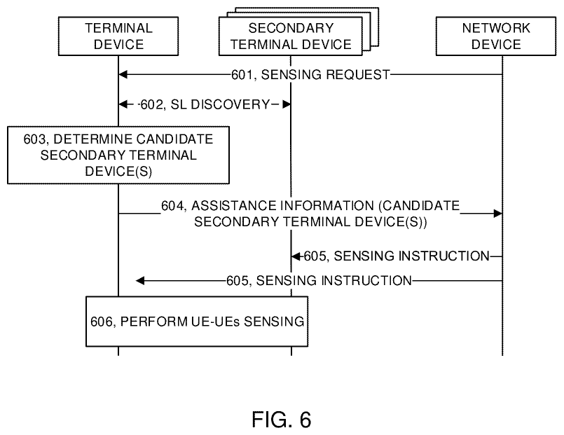

Referring to FIG. 6, FIG. 6 is a flow chart of a method for sensing node selection provided in an embodiment of the disclosure. The method may be applied to the system architecture illustrated in FIG. 1 or FIG. 2. The method includes the following.

At block 601, a network device sends a sensing request to a terminal device.

Exemplarily, an AF sends the sensing request for the terminal device to a core network device, and an SF or an AMF of the core network device sends the sensing request to the terminal device, so that the terminal device reports assistance information to the core network device, and thus the SF or the AMF of the core network device selects a sensing node from a candidate sensing node(s).

Exemplarily, an AF sends the sensing request for the terminal device to a core network device, an SF or an AMF of the core network device sends the sensing request to an access network device, and the access network device sends the sensing request to the terminal device, so that the terminal device reports assistance information to the access network device, and thus the access network device selects a sensing node from a candidate sensing node(s).

Exemplarily, the sensing request in the embodiment contains a sensing type that is terminal device-terminal device sensing; and/or the sensing request contains indication information used for instructing the terminal device to report first assistance information, where the first assistance information indicates a candidate secondary terminal device(s).

At block 602, the terminal device and a secondary terminal device(s) perform SL discovery.

If the sensing request instructs the terminal device to perform sensing with a secondary terminal device, the terminal device performs SL discovery to obtain an SL discovery result, where the SL discovery result indicates a secondary terminal device(s) participating in the SL discovery; and the terminal device sends the first assistance information to the network device, where the first assistance information is generated based on the SL discovery result.

By means of SL discovery, a secondary terminal device(s) capable of performing SL communication with the terminal device can be discovered.

Exemplarily, two SL discovery models are provided in the embodiment.

SL discovery model A, “I am here”:

In such an SL discovery model, two roles are defined for terminal devices participating in SL discovery: an announcing terminal device (a secondary terminal device is referred to as an announcing terminal device in the SL discovery model) and a monitoring terminal device (the terminal device is referred to as a monitoring terminal device in the SL discovery model).

An announcing UE announces certain information that can be used by a UE in proximity that have permission to discover. A monitoring UE monitors certain information that is sent by the announcing UE and the monitoring UE is interested in. The announcing UE broadcasts a discovery message at a predefined discovery interval, and a monitoring UE that is interested in the message reads and processes the discovery message. That is, this model is equivalent to that the announcing UE broadcasts “I am here”, and the monitoring UE monitors the “I am here” message and thus discovers the announcing UE.

In SL discovery model A, a secondary terminal device announces secondary terminal device information. The terminal device monitors the secondary terminal device information announced by the secondary terminal device, and generates the SL discovery result based on the secondary terminal device information.

The secondary terminal device information includes a secondary terminal device identity (ID).

The terminal device integrates the received information of multiple secondary terminal devices to obtain the SL discovery result, where the SL discovery result includes an ID of each of at least one secondary terminal device discovered by the terminal device in SL discovery.

The first assistance information includes the ID of each of at least one secondary terminal device discovered by the terminal device in SL discovery.

SL discovery model B, “who is there”/“are you there”:

In such an SL discovery model, two roles are defined for terminal devices participating in SL discovery: a discoverer terminal device (the terminal device is referred to as a discoverer terminal device in the SL discovery model) and a discoveree terminal device (a secondary terminal device is referred to as a discoveree terminal device in the SL discovery model).

A discoverer UE transmits a request containing certain information about what the discoverer UE is interested to discover. A discoveree UE receives the request, responds with some message related to the request of the discoverer UE, and sends a response. The discoverer UE monitors the response and discovers the discoveree UE. That is, this model is equivalent to that the discoverer UE sends “who is there”/“are you there”, and the discoveree UE responds to this message.

In SL discovery model B, the terminal device sends a discovery request. A secondary terminal device receives the discovery request and sends a discovery response to the terminal device. The terminal device monitors the discovery response sent by the secondary terminal device, and generates the SL discovery result based on the discovery response.

The discovery response contains an ID of the secondary terminal device.

The terminal device integrates multiple received discovery responses to obtain the SL discovery result, where the SL discovery result includes an ID of each of at least one secondary terminal device discovered by the terminal device in SL discovery.

The first assistance information includes the ID of each of at least one secondary terminal device discovered by the terminal device in SL discovery.

At block 603, the terminal device determines the candidate secondary terminal device(s).

The terminal device performs SL discovery, and determines the candidate secondary terminal device(s) based on the SL discovery result. The UE determines an available candidate secondary terminal device(s) near the UE based on the SL discovery result, and reports the assistance information to the network device, where the assistance information indicates the candidate secondary terminal device(s).

At block 604, the terminal device sends the assistance information to the network device, where the assistance information indicates the candidate secondary terminal device(s).

If the sensing request instructs the terminal device to perform sensing with a secondary terminal device, the terminal device sends the first assistance information to the network device, where the first assistance information indicates the candidate secondary terminal device(s).

At block 605, the network device sends a sensing instruction to at least one of the terminal device or a secondary terminal device(s).

The network device receives the first assistance information sent by the terminal device, selects at least one secondary terminal device as a sensing node from the candidate secondary terminal device(s) indicated by the first assistance information, and sends the sensing instruction to the terminal device and/or the at least one secondary terminal device each serving as a sensing node.

At block 606, the terminal device and the secondary terminal device(s) perform terminal device-terminal device sensing.

The terminal device and/or the at least one secondary terminal device receives the sensing instruction sent by the network device, and perform UE-UE(s) sensing.

As can be seen, since the network device cannot know distribution of other UEs around the terminal device, the network device is unable to configure a suitable secondary UE(s) for the terminal device to perform sensing operations. According to the method provided in the embodiment, by means of SL discovery, a UE can recommend to the network device a suitable secondary UE(s) near the UE based on the SL discovery result.

According to the method provided in the embodiment, if the network device instructs the terminal device to perform sensing with a secondary terminal device, the terminal device performs SL discovery, discovers a secondary terminal device(s) located near the terminal device and capable of performing sensing with the terminal device, and feeds back the first assistance information to the network device, where the first assistance information indicates the candidate secondary terminal device(s), so that the network device selects, from the candidate secondary terminal device(s), a secondary terminal device(s) that is to participate in the current sensing. The first assistance information is reported by the terminal device, so that the network device can determine, based on the first assistance information, other terminal devices located near the terminal device, and thus can select a suitable secondary terminal device(s) for the terminal device.

2. The assistance information indicates a candidate secondary access network device(s).

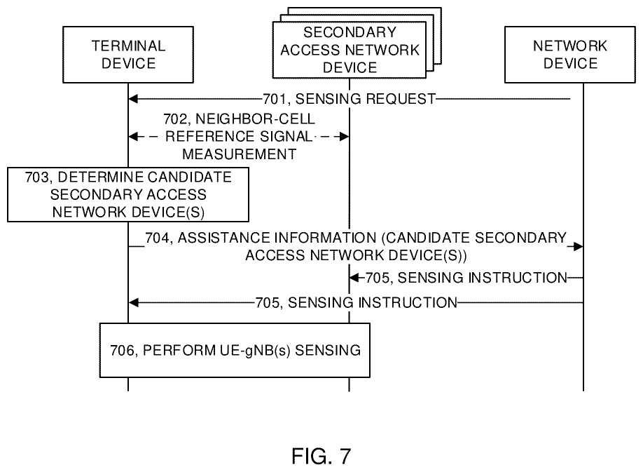

Referring to FIG. 7, FIG. 7 is a flow chart of a method for sensing node selection provided in an embodiment of the disclosure. The method may be applied to the system architecture illustrated in FIG. 1 or FIG. 2. The method includes the following.

At block 701, a network device sends a sensing request to a terminal device.

Exemplarily, the sensing request contains a sensing type that is terminal device-access network device uplink sensing, or the sensing request contains a sensing type that is terminal device-access network device downlink sensing; and/or the sensing request contains indication information used for instructing the terminal device to report second assistance information, where the second assistance information indicates a candidate secondary access network device(s).

At block 702, the terminal device and a secondary access network device(s) perform neighbor-cell reference signal measurement.

If the sensing request instructs the terminal device to perform sensing with a secondary access network device, the terminal device performs neighbor-cell reference signal measurement to obtain a measurement result, where the measurement result indicates a secondary access network device(s) participating in the neighbor-cell reference signal measurement; and sends the second assistance information to the network device, where the second assistance information is generated based on the measurement result.

The neighbor-cell reference signal measurement includes at least one of: a neighbor-cell reference signal received power (RSRP) measurement or a neighbor-cell reference signal received quality (RSRQ) measurement.

By means of neighbor-cell reference signal measurement, a secondary access network device(s) capable of communicating with the terminal device can be discovered.

The measurement result includes an ID of each of at least one secondary access network device participating in the neighbor-cell reference signal measurement.

The second assistance information includes the ID of each of at least one secondary access network device participating in the neighbor-cell reference signal measurement.

Exemplarily, a secondary access network device sends a reference signal to the terminal device, and the terminal device receives the reference signal to perform neighbor-cell reference signal measurement.

At block 703, the terminal device determines the candidate secondary access network device(s).

The terminal device performs neighbor-cell reference signal measurement, and determines the candidate secondary access network device(s) based on the measurement result. A UE determines, based on an RSRP/RSRQ measurement result, an available candidate secondary gNB(s) near the UE, and reports assistance information to the network device, where the assistance information indicates the candidate secondary gNB(s).

At block 704, the terminal device sends the assistance information to the network device, where the assistance information indicates the candidate secondary access network device(s).

If the sensing request instructs the terminal device to perform sensing with a secondary access network device, the terminal device sends the second assistance information to the network device, where the second assistance information indicates the candidate secondary access network device(s).

At block 705, the network device sends a sensing instruction to at least one of the terminal device or a secondary access network device(s).

The network device receives the second assistance information sent by the terminal device, selects at least one access network device as at least one sensing node from the candidate secondary access network device(s) indicated by the second assistance information and an access network device (serving access network device), and sends the sensing instruction to the terminal device and/or the at least one access network device each serving as a sensing node.

That is, the sensing node(s) selected by the network device may be the candidate secondary access network device(s) indicated by the second assistance information, or may be the access network device (serving access network device) accessed by the terminal device. That is, the secondary access network device(s) in the operation at 705 may include the serving access network device.

At block 706, the terminal device and the secondary access network device perform terminal device-access network device sensing.

The terminal device and/or the at least one secondary access network device receives the sensing instruction sent by the network device, and performs UE-gNB(s) sensing.

As can be seen, although the network device can know some about distribution of access network devices located around the terminal device, the network device is still unable to configure accurately a suitable neighbor gNB(s) for the terminal device to perform sensing except a serving gNB for the terminal device. According to the method provided in the embodiment, by means of neighbor-cell RSRP/RSRQ measurement, a UE recommends to the network device a suitable secondary gNB(s) near the UE based on a neighbor-cell RSRP/RSRQ measurement result, thereby assisting the network device to configure the sensing instruction.

According to the method provided in the embodiment, if the network device instructs the terminal device to perform sensing with a secondary access network device, the terminal device performs neighbor-cell reference signal measurement to discover a secondary access network device(s) that is located near the terminal device and capable of performing sensing with the terminal device, and feeds back the second assistance information to the network device, where the second assistance information indicates the candidate secondary access network device(s), so that the network device selects, from the candidate secondary access network device(s) and the serving access network device, a secondary access network device(s) that is to participate in the current sensing. The second assistance information is reported by the terminal device, and as such, it is conducive for the network device to determine an access network device(s) located near the terminal device based on the second assistance information, thereby selecting a suitable secondary access network device(s) for the terminal device.

3. The assistance information includes the location information of the terminal device.

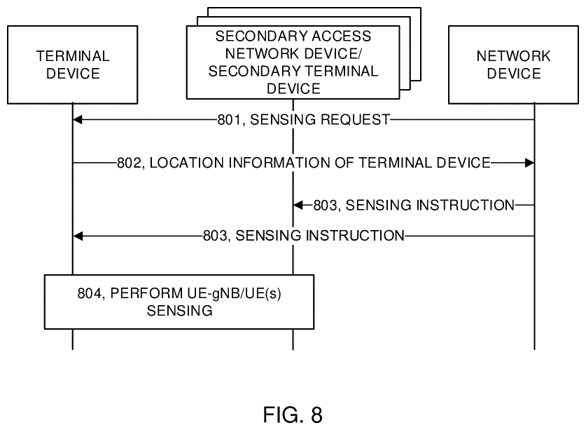

Referring to FIG. 8, FIG. 8 is a flow chart of a method for sensing node selection provided in an embodiment of the disclosure. The method may be applied to the system architecture illustrated in FIG. 1 or FIG. 2. The method includes the following.

At block 801, a network device sends a sensing request to a terminal device.

Exemplarily, the sensing request contains a sensing type that is terminal device-terminal device sensing, or the sensing request contains a sensing type that is terminal device-access network device uplink sensing/terminal device-access network device sensing, or the sensing request contains a sensing type that is terminal device-access network device downlink sensing/terminal device-access network device sensing; and/or the sensing request contains indication information used for instructing the terminal device to report third assistance information, where the third assistance information includes location information of the terminal device.

If the sensing request instructs the terminal device to perform sensing with a secondary sensing node, the terminal device performs positioning of the terminal device to obtain the location information of the terminal device, where the secondary sensing node includes at least one of a secondary access network device or a secondary terminal device; and the terminal device sends the third assistance information to the network device, where the third assistance information includes the location information. The location information is used for assisting the network device to determine a candidate secondary sensing node, where a distance between the candidate secondary sensing node and the terminal device is less than a threshold value.

Exemplarily, the terminal device performs global navigation satellite system (GNSS)-based positioning, to obtain the location information of the terminal device.

At block 802, the terminal device sends the location information of the terminal device to the network device.

If the sensing request instructs the terminal device to perform sensing with a secondary sensing node, the terminal device sends the third assistance information to the network device, where the third assistance information includes the location information of the terminal device. The secondary sensing node includes at least one of a secondary access network device or a secondary terminal device.

At block 803, the network device sends a sensing instruction to at least one of the terminal device or a secondary access network device/secondary terminal device.

The network device receives the third assistance information. If the terminal device is to perform sensing with a secondary access network device, the network device reads secondary-access-network location information of each secondary access network device in a secondary access network device set. Exemplarily, the secondary access network device set may be determined according to the location information of the terminal device, for example, the secondary access network device set includes all access network devices in a region that the terminal device belongs to. Based on the location information and the secondary-access-network location information, the network device determines a secondary access network device in the secondary access network device set as a candidate secondary access network device, where a distance between the secondary access network device and the terminal device is less than a threshold value.

If the terminal device is to perform sensing with another terminal device(s), the network device receives secondary-terminal location information sent by a secondary terminal device(s), and determines, based on the location information and the secondary-terminal location information, a secondary terminal device as a candidate secondary terminal device, where a distance between the secondary terminal device and the terminal device is less than a threshold value.

The network device determines an available secondary sensing node near a UE based on location information reported by the UE, and sends the sensing instruction to the UE and the secondary sensing node in order for UE-UE sensing, UE-gNB downlink sensing, UE-gNB uplink sensing, etc.

At block 804, the terminal device and the secondary access network device perform terminal device-access network device sensing, or the terminal device and the secondary terminal device perform terminal device-terminal device sensing.

As can be seen, according to the method provided in the embodiment, the terminal device feeds back the third assistance information to the network device, where the third assistance information includes the location information of the terminal device, so that the network device selects a sensing node(s) located near the terminal device based on the location information. The third assistance information is reported by the terminal device, and as such, the network device can determine, based on the third assistance information, other terminal devices or access network devices located near the terminal device, and thus can select a suitable secondary sensing node for the terminal device.

4. The assistance information includes at least one type of the three types of assistance information described above.

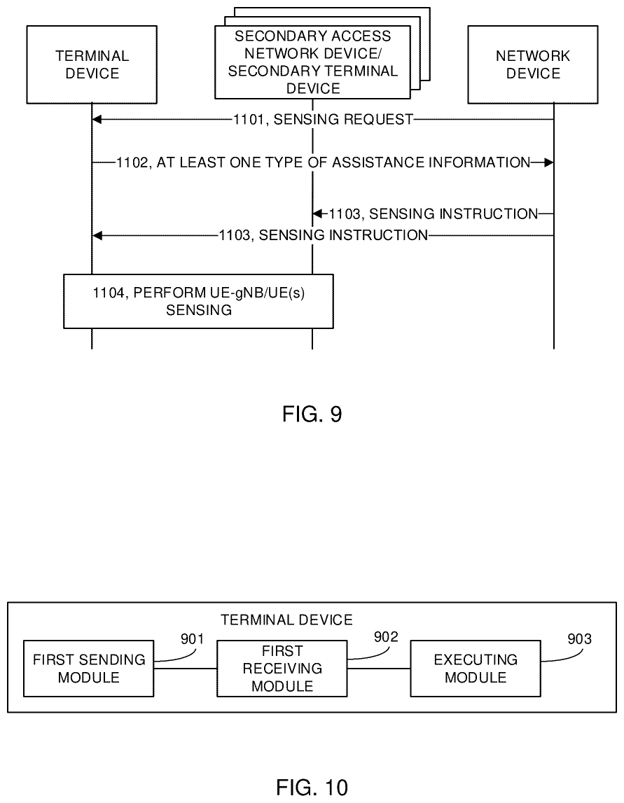

Referring to FIG. 9, FIG. 9 is a flow chart of a method for sensing node selection provided in an embodiment of the disclosure. The method may be applied to the system architecture illustrated in FIG. 1 or FIG. 2. The method includes the following.

At block 1101, a network device sends a sensing request to a terminal device.

Exemplarily, the sensing request indicates no sensing type, that is, which type of sensing node is to work with the terminal device to perform sensing is not yet determined by the network device. The terminal device firstly reports assistance information, and the network device selects a sensing node(s) according to the assistance information.

Exemplarily, the assistance information includes three types: first assistance information, second assistance information, and third assistance information. In the embodiment, the terminal device may report at least one type of the three types of assistance information.

In an optional implementation, if the sensing request indicates no sensing type and does not contain the indication information that is used for instructing the terminal device to report the assistance information, the terminal device reports all types of assistance information that can be obtained.

That is, if the sensing request indicates no sensing type and the sensing request does not instruct the terminal device to report the assistance information, the terminal device sends a second set of assistance information to the network device. The second set of assistance information includes at least one of: the first assistance information, the second assistance information, or the third assistance information, where the first assistance information indicates a candidate secondary terminal device(s), the second assistance information indicates a candidate secondary access network device(s), and the third assistance information includes location information of the terminal device.

Exemplarily, the second set of assistance information includes all assistance information that can be reported by the terminal device.

For example, the network device sends the sensing request to the terminal device, where the sensing request neither indicates the sensing type of the current sensing, nor indicates which type of assistance information needs to be uploaded by the terminal device, the terminal device obtains the assistance information after receiving the sensing request sent by the network device. For example, the terminal device performs positioning to obtain the location information, performs SL discovery to obtain a candidate secondary terminal device(s), and performs neighbor-cell reference signal measurement to obtain a candidate secondary access network device(s). After performing the above procedures, the terminal device obtains at least one type of assistance information successfully, where the at least one type of assistance information is the second set of assistance information. The terminal device reports the second set of assistance information to the network device.

In another optional implementation, if the sensing request indicates no sensing type but the sensing request contains indication information indicating which type of assistance information is to be reported by the terminal device, the terminal device reports the assistance information of the corresponding type according to requirements of the indication information.

That is, if the sensing request instructs the terminal device to report a first set of assistance information, the terminal device sends the first set of assistance information to the network device. The first set of assistance information includes at least one of: the first assistance information, the second assistance information, or the third assistance information, where the first assistance information indicates a candidate secondary terminal device(s), the second assistance information indicates a candidate secondary access network device(s), and the third assistance information includes location information of the terminal device. The sensing request contains indication information used for instructing the terminal device to report the first set of assistance information.

Exemplarily, the first set of assistance information includes assistance information that needs to be uploaded by the terminal device according to indication in the sensing request of the network device.

For example, the sensing type of the current sensing is not yet determined by the network device. The network device sends the sensing request to the terminal device, where the sensing request does not indicate the sensing type of the current sensing, but the sensing request contains indication information indicative of that the terminal device needs to upload the first assistance information and the second assistance information. After receiving the sensing request sent by the network device, the terminal device obtains the first assistance information and the second assistance information. In this case, the first assistance information and the second assistance information form the first set of assistance information. The terminal device reports the first set of assistance information to the network device.

Exemplarily, for the manner in which the terminal device obtains the first assistance information, the second assistance information, and the third assistance information, reference can be made to the manner in the embodiments illustrated in FIG. 6, FIG. 7, or FIG. 8.

At block 1102, the terminal device sends at least one type of assistance information to the network device.

For example, the terminal device sends the first set of assistance information to the network device, or the terminal device sends the second set of assistance information to the network device.

At block 1103, the network device sends a sensing instruction to at least one of the terminal device or the secondary access network device/secondary terminal device.

The network device receives the at least one type of assistance information, and selects a sensing node (secondary sensing node) for the terminal device based on the at least one type of assistance information. The network device sends the sensing instruction to a UE and the secondary sensing node in order for UE-UE sensing, UE-gNB downlink sensing, UE-gNB uplink sensing, etc.

At block 1104, the terminal device and the secondary access network device perform terminal device-access network device sensing, or the terminal device and the secondary terminal device perform terminal device-terminal device sensing.

As can be seen, according to the method provided in the embodiment, if no sensing type is determined by the network device, the terminal device may firstly send at least one type of assistance information, and then the network device selects a secondary sensing node for the terminal device based on the at least one type of assistance information. The sensing request may contain indication information used for instructing the terminal device to upload the at least one type of assistance information, or the sensing request may not contain the indication information. The terminal device reports the at least one type of assistance information based on the indication information, or the terminal device reports all assistance information that can be obtained by the terminal device, so that the network device can determine, based on the at least one type of assistance information, other terminal devices or access network devices located near the terminal device, thereby selecting a suitable secondary sensing node for the terminal device.

FIG. 10 is a structural block diagram of an apparatus for sensing node selection provided in an exemplary embodiment of the disclosure. The apparatus may be implemented as a terminal device or as a part of the terminal device. The apparatus includes a first receiving module 902 and a first sending module 901. The first receiving module 902 is configured to receive a sensing request sent by a network device. The first sending module 901 is configured to send assistance information to the network device according to the sensing request, where the assistance information is used for determining a candidate sensing node, and the candidate sensing node is used for assisting the network device to select a sensing node that is to work with a terminal device to perform sensing.

In an optional embodiment, the first sending module 901 is configured to send first assistance information to the network device if the sensing request instructs the terminal device to perform sensing with a secondary terminal device, where the first assistance information indicates a candidate secondary terminal device.

In an optional embodiment, the apparatus further includes an executing module 903. The executing module 903 is configured to perform SL discovery to obtain an SL discovery result if the sensing request instructs the terminal device to perform sensing with the secondary terminal device, where the SL discovery result indicates a secondary terminal device participating in the SL discovery. The first sending module 901 is configured to send the first assistance information to the network device, where the first assistance information is generated based on the SL discovery result.

In an optional embodiment, the executing module 903 is configured to: monitor secondary terminal device information announced by the secondary terminal device; and generate the SL discovery result based on the secondary terminal device information.

In an optional embodiment, the executing module 903 is configured to: send a discovery request; monitor a discovery response sent by the secondary terminal device; and generate the SL discovery result based on the discovery response.

In an optional embodiment, that the sensing request instructs the terminal device to perform sensing with the secondary terminal device includes the following: the sensing request contains a sensing type that is terminal device-terminal device sensing; and/or the sensing request contains indication information used for instructing the terminal device to report the first assistance information.

In an optional embodiment, the first sending module 901 is configured to send second assistance information to the network device if the sensing request instructs the terminal device to perform sensing with a secondary access network device, where the second assistance information indicates a candidate secondary access network device.

In an optional embodiment, the apparatus further includes an executing module 903. The executing module 903 is configured to perform neighbor-cell reference signal measurement to obtain a measurement result if the sensing request instructs the terminal device to perform sensing with the secondary access network device, where the measurement result indicates a secondary access network device participating in the neighbor-cell reference signal measurement. The first sending module 901 is configured to send the second assistance information to the network device, where the second assistance information is generated based on the measurement result.

In an optional embodiment, the neighbor-cell reference signal measurement includes at least one of: neighbor-cell RSRP measurement or neighbor-cell RSRQ measurement.

In an optional embodiment, that the sensing request instructs the terminal device to perform sensing with the secondary access network device includes the following: the sensing request contains a sensing type that is terminal device-access network device uplink sensing, or the sensing request contains a sensing type that is terminal device-access network device downlink sensing; and/or the sensing request contains indication information used for instructing the terminal device to report the second assistance information.

In an optional embodiment, the first sending module 901 is configured to send third assistance information to the network device if the sensing request instructs the terminal device to perform sensing with a secondary sensing node, where the third assistance information includes location information of the terminal device, and the secondary sensing node includes at least one of a secondary access network device or a secondary terminal device.

In an optional embodiment, the apparatus further includes an executing module 903. The executing module 903 is configured to perform positioning of the terminal device to obtain the location information if the sensing request instructs the terminal device to perform sensing with the secondary sensing node. The first sending module 901 is configured to send the third assistance information to the network device, where the third assistance information includes the location information.

In an optional embodiment, the location information is used for assisting the network device to determine a candidate secondary sensing node, where a distance between the candidate secondary sensing node and the terminal device is less than a threshold value.

In an optional embodiment, the sensing request instructs the terminal device to perform sensing with the secondary sensing node as follows: the sensing request contains a sensing type that is terminal device-terminal device sensing, or the sensing request contains a sensing type that is terminal device-access network device uplink sensing, or the sensing request contains a sensing type that is terminal device-access network device downlink sensing; and/or the sensing request contains indication information used for instructing the terminal device to report the third assistance information.

In an optional embodiment, the first receiving module 902 is configured to receive a sensing instruction sent by the network device, where the sensing instruction is used for instructing the terminal device to perform sensing with the sensing node selected by the network device.

In an optional embodiment, the network device includes at least one of: an access network device, an AMF of a core network device, or an SF of the core network device.

In an optional embodiment, the first sending module 901 is configured to send a first set of assistance information to the network device if the sensing request instructs the terminal device to report the first set of assistance information. The first set of assistance information includes at least one of: first assistance information, second assistance information, or third assistance information, where the first assistance information indicates a candidate secondary terminal device, the second assistance information indicates a candidate secondary access network device, and the third assistance information includes location information of the terminal device.

In an optional embodiment, that the sensing request instructs the terminal device to report the first set of assistance information includes the following: the sensing request contains indication information used for instructing the terminal device to report the first set of assistance information.

In an optional embodiment, the first sending module 901 is configured to send a second set of assistance information to the network device if the sensing request indicates no sensing type and the sensing request does not instruct the terminal device to report the assistance information. The second set of assistance information includes at least one of: first assistance information, second assistance information, or third assistance information, where the first assistance information indicates a candidate secondary terminal device, the second assistance information indicates a candidate secondary access network device, and the third assistance information includes location information about the terminal device.

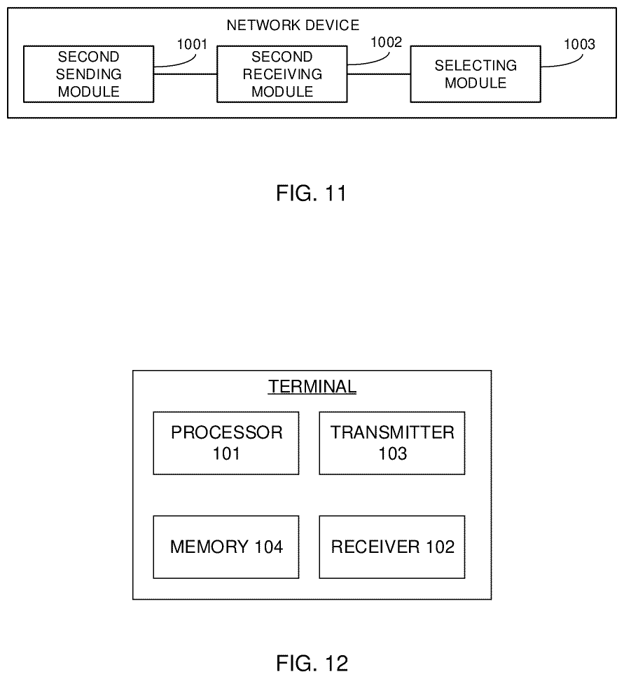

FIG. 11 is a structural block diagram of an apparatus for sensing node selection provided in an exemplary embodiment of the disclosure. The apparatus may be implemented as a network device. The apparatus includes a second sending module 1001 and a selecting module 1003. The second sending module 1001 is configured to send a sensing request to a terminal device, where the sensing request is used for instructing the terminal device to send assistance information, and the assistance information is used for determining a candidate sensing node. The selecting module 1003 is configured to select, from the candidate sensing node, a sensing nodes that is to work with the terminal device to perform sensing.

In an optional embodiment, the assistance information includes first assistance information, where the first assistance information indicates a candidate secondary terminal device. The first assistance information is sent by the terminal device if the sensing request instructs the terminal device to perform sensing with a secondary terminal device.

In an optional embodiment, the first assistance information is generated based on an SL discovery result, the SL discovery result is obtained by the terminal device through SL discovery, and the SL discovery result indicates a secondary terminal device participating in the SL discovery.

In an optional embodiment, the SL discovery result is generated by the terminal device based on secondary terminal device information monitored, where the secondary terminal device information is announced by the secondary terminal device.

In an optional embodiment, the SL discovery result is generated by the terminal device based on a discovery response monitored, and the discovery response is sent by the secondary terminal device in response to a discovery request sent by the terminal device.

In an optional embodiment, that the sensing request instructs the terminal device to perform sensing with the secondary terminal device includes the following: the sensing request contains a sensing type that is terminal device-terminal device sensing; and/or the sensing request contains indication information used for instructing the terminal device to report the first assistance information.

In an optional embodiment, the assistance information includes second assistance information, where the second assistance information indicates a candidate secondary access network device. The second assistance information is sent by the terminal device if the sensing request instructs the terminal device to perform sensing with a secondary access network device.

In an optional embodiment, the second assistance information is generated based on a measurement result, the measurement result is obtained by the terminal device through neighbor-cell reference signal measurement, and the measurement result indicates the secondary access network device participating in the neighbor-cell reference signal measurement.

In an optional embodiment, the neighbor-cell reference signal measurement includes at least one of: neighbor-cell RSRP measurement or neighbor-cell RSRQ measurement.

In an optional embodiment, that the sensing request instructs the terminal device to perform sensing with the secondary access network device includes the following: the sensing request contains a sensing type that is terminal device-access network device uplink sensing, or the sensing request contains a sensing type that is terminal device-access network device downlink sensing; and/or the sensing request contains indication information used for instructing the terminal device to report the second assistance information.

In an optional embodiment, the assistance information includes third assistance information, and the third assistance information includes location information of the terminal device. The third assistance information is sent by the terminal device if the sensing request instructs the terminal device to perform sensing with a secondary sensing node. The secondary sensing node includes at least one of a secondary access network device or a secondary terminal device.

In an optional embodiment, the location information is obtained by the terminal device through positioning of the terminal device.

In an optional embodiment, the secondary sensing node includes the secondary access network device, and the selecting module 1003 is configured to: read secondary-access-network location information of each secondary access network device in a secondary access network device set; and based on the location information and the secondary-access-network location information, determine a secondary access network device in the secondary access network device set as a candidate secondary access network device, where a distance between the secondary access network device and the terminal device is less than a threshold value.

In an optional embodiment, the secondary sensing node includes the secondary terminal device. The apparatus further includes a second receiving module 1002. The second receiving module 1002 is configured to receive secondary-terminal location information sent by the secondary terminal device. The selecting module 1003 is configured to determine a secondary terminal device as a candidate secondary terminal device based on the location information and the secondary-terminal location information, where a distance between the secondary terminal device and the terminal device is less than a threshold value.

In an optional embodiment, the sensing request instructs the terminal device to perform sensing with the secondary sensing node as follows: the sensing request contains a sensing type that is terminal device-terminal device sensing, or the sensing request contains a sensing type that is terminal device-access network device uplink sensing, or the sensing request contains a sensing type that is terminal device-access network device downlink sensing; and/or the sensing request contains indication information used for instructing the terminal device to report the third assistance information.

In an optional embodiment, the second sending module 1001 is configured to send a sensing instruction to at least one of the terminal device or the sensing node, where the sensing instruction is used for instructing the terminal device to perform sensing with the sensing node.

In an optional embodiment, the network device includes at least one of: an access network device, an AMF of a core network device, or an SF of the core network device.

In an optional embodiment, the assistance information includes a first set of assistance information. The first set of assistance information is sent by the terminal device if the sensing request instructs the terminal device to report the first set of assistance information. The first set of assistance information includes at least one of: first assistance information, second assistance information, or third assistance information, where the first assistance information indicates a candidate secondary terminal device, the second assistance information indicates a candidate secondary access network device, and the third assistance information includes location information about the terminal device.

In an optional embodiment, the sensing request instructs the terminal device to report the first set of assistance information as follows: the sensing request contains indication information used for instructing the terminal device to report the first set of assistance information.

In an optional embodiment, the assistance information may include a second set of assistance information. The first set of assistance information is sent by the terminal device if the sensing request indicates no sensing type and the sensing request does not instruct the terminal device to report the assistance information. The second set of assistance information includes at least one of first assistance information, second assistance information, or third assistance information, where the first assistance information indicates a candidate secondary terminal device, the second assistance information indicates a candidate secondary access network device, and the third assistance information includes location information about the terminal device.

FIG. 12 is a schematic structural diagram of a communication device (a terminal device or a network device) provided in an exemplary embodiment of the disclosure. The communication device includes a processor 101, a receiver 102, a transmitter 103, and a memory 104.

The processor 101 includes one or more processing cores. The processor 101 is configured to execute various function applications and information processing by running software programs and modules.

The receiver 102 and the transmitter 103 may be implemented as a communication assembly, where the communication assembly may be a communication chip, and the communication assembly may be referred to as a transceiver.

The memory 104 is coupled with the processor 101.

The memory 104 may be configured to store at least one instruction. The processor 101 is configured to execute the at least one instruction, so as to implement various operations in the foregoing method embodiments.

In addition, the memory 104 may be implemented by any type of volatile storage device or non-volatile storage device or a combination thereof. The volatile storage device or non-volatile storage device includes, but is not limited to, a magnetic disk or an optical disk, an electrically-erasable programmable read only memory (EEPROM), an EPROM, a static random access memory (SRAM), a ROM, a magnetic memory, a flash memory, a programmable ROM (PROM).

When the communication device is implemented as a terminal device, the processor and the transceiver in the communication device involved in the embodiments of the disclosure may perform the operations implemented by the terminal device in the foregoing method illustrated in any one of FIG. 3 to FIG. 9 described above, which will not be described again herein.

In a possible implementation, the communication device is implemented as a terminal device. The transceiver is configured to: receive a sensing request sent by a network device; and send assistance information to the network device according to the sensing request, where the assistance information is used for determining a candidate sensing node, and the candidate sensing node is used for assisting the network device to select the sensing node a sensing node that is to work with the terminal device to perform sensing.

When the communication device is implemented as a network device, the processor and the transceiver in the communication device involved in the embodiments of the disclosure may perform the operations implemented by the network device in the foregoing method illustrated in any one of FIG. 3 to FIG. 9, which will not be described again herein.

In a possible implementation, the communication device is implemented as a network device. The transceiver is configured to: send a sensing request to a terminal device, where the sensing request is used for instructing the terminal device to send assistance information, and the assistance information is used for determining a candidate sensing node. The processor is configured to select, from the candidate sensing node, a sensing node that is to work with the terminal device to perform sensing.

In an exemplary embodiment, a computer-readable storage medium is further provided. The computer-readable storage medium is configured to store at least one instruction, at least one program, a code set, or an instruction set which is loaded and executed by a processor so as to implement the method performed by a communication device provided various method embodiments described above.

In an exemplary embodiment, a chip is further provided. The chip includes a programmable logic circuit and/or a program instruction, and is configured to implement the method described in the foregoing aspects when run on a computer device.

In an exemplary embodiment, a computer program product is further provided. The computer program product, when executed by a processor of a computer device, is operable with the computer device to implement the method described in the foregoing aspects.

Those of ordinary skill in the art may understand that all or some of the operations in the foregoing embodiments may be implemented by hardware, or may be implemented by a program instructing related hardware. The program may be stored in a computer-readable storage medium. The storage medium may be a ROM, a magnetic disk, or an optical disk.

The foregoing illustrations are merely optional embodiments of the disclosure, and are not intended to limit the disclosure. Any modification, equivalent replacement, and improvement made within the spirit and principle of the disclosure shall all belong to the protection scope of the disclosure.

I/We claim:

1. A method for sensing node selection, applied to a terminal device and comprising:
receiving a sensing request sent by a network device; and
sending assistance information to the network device according to the sensing request, wherein the assistance information is used for determining at least one candidate sensing node, and the at least one candidate sensing node is used for assisting the network device to select at least one sensing node that is to work with the terminal device to perform sensing.

2. The method of claim 1, wherein sending the assistance information to the network device according to the sensing request comprises:
sending first assistance information to the network device in response to the sensing request instructing the terminal device to perform sensing with at least one secondary terminal device, wherein the first assistance information indicates at least one candidate secondary terminal device.

3. The method of claim 2, wherein sending the first assistance information to the network device in response to the sensing request instructing the terminal device to perform sensing with the at least one secondary terminal device comprises:
performing sidelink (SL) discovery to obtain an SL discovery result in response to the sensing request instructing the terminal device to perform sensing with the at least one secondary terminal device, wherein the SL discovery result indicates at least one secondary terminal device participating in the SL discovery; and
sending the first assistance information to the network device, wherein the first assistance information is generated based on the SL discovery result.

4. The method of claim 2, wherein that the sensing request instructs the terminal device to perform sensing with the at least one secondary terminal device, comprises that:
the sensing request contains a sensing type that is terminal device-terminal device sensing; and/or
the sensing request contains indication information used for instructing the terminal device to report the first assistance information.

5. The method of claim 1, wherein sending the assistance information to the network device according to the sensing request comprises:
sending second assistance information to the network device in response to the sensing request instructing the terminal device to perform sensing with at least one secondary access network device, wherein the second assistance information indicates at least one candidate secondary access network device.

6. The method of claim 5, wherein sending the second assistance information to the network device in response to the sensing request instructing the terminal device to perform sensing with the at least one secondary access network device comprises:
performing neighbor-cell reference signal measurement to obtain a measurement result in response to the sensing request instructing the terminal device to perform sensing with the at least one secondary access network device, wherein the measurement result indicates at least one secondary access network device participating in the neighbor-cell reference signal measurement; and
sending the second assistance information to the network device, wherein the second assistance information is generated based on the measurement result.

7. The method of claim 5, wherein that the sensing request instructs the terminal device to perform sensing with the at least one secondary access network device comprises that:
the sensing request contains a sensing type that is terminal device-access network device uplink sensing; or the sensing request contains a sensing type that is terminal device-access network device downlink sensing; and/or
the sensing request contains indication information used for instructing the terminal device to report the second assistance information.

8. The method of claim 1, wherein sending the assistance information to the network device according to the sensing request comprises:
sending third assistance information to the network device in response to the sensing request instructing the terminal device to perform sensing with at least one secondary sensing node, wherein the third assistance information comprises location information of the terminal device, and wherein
the secondary sensing node comprises at least one of: a secondary access network device or a secondary terminal device.

9. The method of claim 8, wherein sending the third assistance information to the network device in response to the sensing request instructing the terminal device to perform sensing with the at least one secondary sensing node comprises:
performing positioning of the terminal device to obtain the location information in response to the sensing request instructing the terminal device to perform sensing with the at least one secondary sensing node; and
sending the third assistance information to the network device, wherein the third assistance information comprises the location information.

10. The method of claim 8, wherein that the sensing request instructs the terminal device to perform sensing with the at least one secondary sensing node comprises that:
the sensing request contains a sensing type that is terminal device-terminal device sensing; or the sensing request contains a sensing type that is terminal device-access network device uplink sensing; or the sensing request contains a sensing type that is terminal device-access network device downlink sensing; and/or
the sensing request contains indication information used for instructing the terminal device to report the third assistance information.

11. A terminal device, comprising:
a transceiver;
a processor coupled to the transceiver; and
a memory storing a computer program which, when executed by the processor, causes the terminal device to:
receive a sensing request sent by a network device; and
send assistance information to the network device according to the sensing request, wherein the assistance information is used for determining at least one candidate sensing node, and the at least one candidate sensing node is used for assisting the network device to select at least one sensing node that is to work with the terminal device to perform sensing.

12. The terminal device of claim 11, wherein the computer program is further executed by the processor to cause the terminal device to:
send first assistance information to the network device in response to the sensing request instructing the terminal device to perform sensing with at least one secondary terminal device, wherein the first assistance information indicates at least one candidate secondary terminal device.

13. The terminal device of claim 12, wherein the computer program is further executed by the processor to cause the terminal device to:
perform sidelink (SL) discovery to obtain an SL discovery result in response to the sensing request instructing the terminal device to perform sensing with the at least one secondary terminal device, wherein the SL discovery result indicates at least one secondary terminal device participating in the SL discovery; and
send the first assistance information to the network device, wherein the first assistance information is generated based on the SL discovery result.

14. The terminal device of claim 12, wherein that the sensing request instructs the terminal device to perform sensing with the at least one secondary terminal device, comprises that:
the sensing request contains a sensing type that is terminal device-terminal device sensing; and/or
the sensing request contains indication information used for instructing the terminal device to report the first assistance information.

15. The terminal device of claim 11, wherein the computer program is further executed by the processor to cause the terminal device to:
send second assistance information to the network device in response to the sensing request instructing the terminal device to perform sensing with at least one secondary access network device, wherein the second assistance information indicates at least one candidate secondary access network device.

16. The terminal device of claim 15, wherein the computer program is further executed by the processor to cause the terminal device to:
perform neighbor-cell reference signal measurement to obtain a measurement result in response to the sensing request instructing the terminal device to perform sensing with the at least one secondary access network device, wherein the measurement result indicates at least one secondary access network device participating in the neighbor-cell reference signal measurement; and
send the second assistance information to the network device, wherein the second assistance information is generated based on the measurement result.

17. The terminal device of claim 15, wherein that the sensing request instructs the terminal device to perform sensing with the at least one secondary access network device comprises that:
the sensing request contains a sensing type that is terminal device-access network device uplink sensing; or the sensing request contains a sensing type that is terminal device-access network device downlink sensing; and/or
the sensing request contains indication information used for instructing the terminal device to report the second assistance information.

18. The terminal device of claim 11, wherein the computer program is further executed by the processor to cause the terminal device:
send third assistance information to the network device in response to the sensing request instructing the terminal device to perform sensing with at least one secondary sensing node, wherein the third assistance information comprises location information of the terminal device, wherein
the secondary sensing node comprises at least one of: a secondary access network device or a secondary terminal device.

19. The terminal device of claim 18, wherein the computer program is further executed by the processor to cause the terminal device to
perform positioning of the terminal device to obtain the location information in response to the sensing request instructing the terminal device to perform sensing with the at least one secondary sensing node; and
send the third assistance information to the network device, wherein the third assistance information comprises the location information.

20. A network device, comprising:
a transceiver;
a processor coupled to the transceiver; and
a memory storing a computer program which, when executed by the processor, causes the network device to:
send a sensing request to a terminal device, wherein the sensing request is used for instructing the terminal device to send assistance information, and the assistance information is used for determining at least one candidate sensing node; and
select, from the at least one candidate sensing node, at least one sensing node that is to work with the terminal device to perform sensing.
